(19) United States
(12) Patent Application Publication
(10) Pub. No.: US 2024/0013475 A1
(43) Pub. Date: Jan. 11, 2024

(54) TRANSPARENCY RANGE FOR VOLUMETRIC VIDEO

(71) Applicant: InterDigital CE Patent Holdings, SAS, Paris (FR)

(72) Inventors: Julien Fleureau, Rennes (FR); Bertrand Chupeau, Rennes (FR); Renaud Dore, Rennes (FR)

(21) Appl. No.: 18/036,556

(22) PCT Filed: Nov. 10, 2021
(86) PCT No.: PCT/EP2021/081260

§ 371 Date: May 11, 2023

(30) Foreign Application Priority Data
Nov. 12, 2020 (EP) 20306369.8

(51) Int. Cl. G06T 15/10; G06T 19/20

(52) U.S. Cl. CPC G06T 15/10; G06T 19/20; G06T 2200/24; G06T 2210/12; G06T 2210/62; G06T 2210/61; G06T 2219/2012

(57) ABSTRACT

Methods, devices and video data encoding a volumetric 3D scene are disclosed. The user is allowed to modify values of rendering effects for some objects of the 3D scene in ranges provided by the content creator or the broadcaster. Metadata describing the possibilities of modifications, the concerned objects and authorized ranges of values are associated with the payload content. On the decoding side, according to these metadata an interface is provided to the user for modifying the values in the authorized ranges.

### 1. TECHNICAL FIELD

The present principles generally relate to the domain of three-dimensional (3D) scene and volumetric video content. The present document is also understood in the context of the encoding, the formatting and the decoding of data representative of the texture and the geometry of a 3D scene for a rendering of volumetric content on end-user devices such as mobile devices or Head-Mounted Displays (HMD).

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

New kinds of picture or video contents appeared including the domain widely called 360° pictures or videos. Such content items allow the user to watch all around himself through pure rotations around a fixed point of view. Even if pure rotations are sufficient for a first omnidirectional video experience, they may quickly become frustrating for the viewer who would expect more freedom. More importantly, it could also induce dizziness as head rotations include small translations of the head which are not reproduced by such experiences.

An alternative to these 360° contents is known as volumetric or 6 Degrees of Freedom (6DoF) video. When watching such videos, in addition to rotations, the user can also translate his head inside the watched content and experience parallax. Such videos considerably increase the feeling of immersion and the perception of the scene depth and also prevent from dizziness by providing consistent visual feedback during head translations. The associated content is basically created by the means of dedicated sensors allowing the simultaneous recording of color and geometry of the scene of interest. The use of rig of color cameras combined with photogrammetry techniques is a common way to do this recording.

While 360° videos come down to a temporal succession of particular images resulting from the un-mapping of spherical textures (lat-long/equirectangular images for instance), 6DoF video “frames” are more complex as they should embed the information from several points of view.

At least two different kinds of volumetric videos may be considered depending on the viewing conditions. The more permissive one (6DoF) allows a complete free navigation inside the video content whereas a second one (3DoF+) restricts the user viewing space to a limited volume. This latter context is a natural compromise between free navigation and passive viewing conditions of an audience member seated in his armchair. This approach is currently considered for standardization within MPEG as an extension of V3C (cf. Committee Draft of

ISO/IEC 23090-5 Information technology—Coded Representation of Immersive Media—part 5: Visual Volumetric Video-based Coding and Video-based Point Cloud Compression) called MPEG For Immersive Video (MIV) (cf. Committee Draft of ISO/IEC 23090-12 Information technology—Coded Representation of Immersive Media—part 12: MPEG Immersive Video) belonging to the MPEG-I standard suite.

Volumetric video makes possible to control the rendering of the video frame presented to the end-user as a post-acquisition process. For instance, it allows to dynamically modify the point of view of the user within the 3D scene to make him experience parallax. But more advanced effects may also be envisioned such as dynamic refocusing or even object removal. A client device receiving a volumetric video encoded, for example, as a regular MIV bitstream may implement transparency effects at the rendering stage by performing, for instance, a spatio-angular culling (and possible patch filtering process) combined with alpha blending.

However, the content producer may want to limit this feature or at least moderate/recommend its usage in some specific cases for narrative, commercial or quality purposes. It would be for instance the case to prevent the user from removing some advertisement required by the broadcaster. In a story telling context, making certain areas transparent/empty could make the whole story inconsistent or not understandable. In addition, removing some parts of the scene could even cause undesirable disocclusions that may affect the visual quality of experience.

Thus, there is a lack for a solution to signal volumetrically located rendering effects (e.g. transparency or color filtering or blurring or contrast adapting) that mixes the requirements from the content producer or the broadcaster and the expectations of the viewer.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to method comprising:
obtaining an atlas image, the atlas image packing patch pictures, the atlas image being representative of a three-dimensional scene and metadata comprising a value range for a rendering effect associated with an object of the three-dimensional scene;
rendering a view of the three-dimensional scene by inverse projecting the pixels of the atlas image for a point of view and by applying a default value for the rendering effect to the pixels used to render the object;
displaying an interface to allow a user to modify the value of the rendering effect in the value range.

In an embodiment, wherein when the value of the rendering effect is modified to a new value, the method comprises:
on condition that the metadata comprise data associating the object with patch pictures of the atlas image,
   on condition that the metadata comprise data associating the object with a bounding box, apply the new value to pixels of the associated patch pictures inverse projected in the bounding box;
   otherwise , apply the new value to pixels of the associated patch pictures;
otherwise, apply the new value to pixels inverse projected in the bounding box.

The present principles also relate to a device comprising a memory associated with a processor configured to implement the different embodiments of the method above.

The present principles also relate to a video data comprising an atlas image, the atlas image packing patch pictures, the atlas image being representative of a three-dimensional scene and metadata comprising a value range for a rendering effect associated with an object of the three-dimensional scene.

### 4. BRIEF DESCRIPTION OF DRAWINGS

The present disclosure will be better understood, and other specific features and advantages will emerge upon reading the following description, the description making reference to the annexed drawings wherein:

FIG. 1 illustrates the atlas-based encoding of volumetric video, according to a non-limiting embodiment of the present principles;

FIG. 2 illustrates differences monoscopic and volumetric acquisition of a picture or a video, according to a non-limiting embodiment of the present principles;

FIG. 3 illustrates the removal/transparency feature in the context of a soccer match volumetric capture, according to a non-limiting embodiment of the present principles;

FIG. 4 shows an example user interface for a rendering device implementing the transparency rendering effect, according to a non-limiting embodiment of the present principles;

FIG. 5 shows an example architecture of a device which may be configured to implement a method described in relation with FIGS. 3 and 4, according to a non-limiting embodiment of the present principles;

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

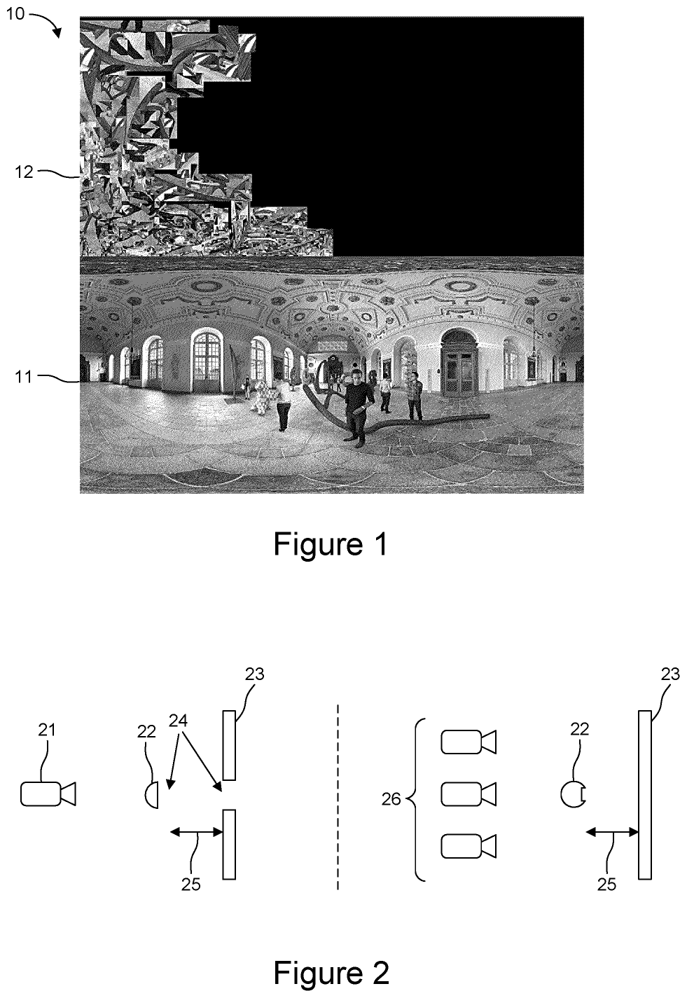

FIG. 1 illustrates the atlas-based encoding of volumetric video. The atlas-based encoding is a set of techniques, for instance proposed by the MPEG-I standard suite, for carrying the volumetric information as a combination of 2D patches 11 and 12 stored in atlas frames 10 which are then video encoded making use of regular codecs (for example HEVC). Each patch represents the projection of a subpart of the 3D input scene as a combination of color, geometry and transparency 2D attributes. The set of all patches is designed at the encoding stage to cover the entire scene while being as less redundant as possible. At the decoding stage, the atlases are video decoded at a first stage and the patches are rendered in a view synthesis process to recover the viewport associated to a desired viewing position. In the example of FIG. 1, patch 11 is the projection of all points visible from a central point of view and patches 12 are the result of the projection of points of the scene according to peripheral points of view. Patch 11 may be used alone for a 360° video rendering.

FIG. 2 illustrates differences monoscopic and volumetric (also called polyscopic or light-field) acquisition of a picture or a video. On the left, monoscopic acquisition uses a unique camera 21 which captures the scene. The distance 25 between an object 22 in the foreground and objects 23 in the background is not captured (it has to be deduced from a pre-known size of objects). In a monoscopic image, information 24 is missing because points of this part of the scene are occluded by foreground object 22. On the right, for a volumetric acquisition of the same scene, a set of cameras 26 located at distinct positions in the 3D space of the scene are used. With this multiple capture, information is known because captured by at least one of the camera and distance 25 may be estimated with precision by comparing the different images of the scene captured at the same instant.

Volumetric acquisition makes possible to control the rendering of the video frame presented to the end-user as a post-acquisition process. For example, it allows to dynamically modify the point of view of the user within the 3D scene to make him experiences parallax. More advanced effects may be also envisioned such as dynamic refocusing or object removal.

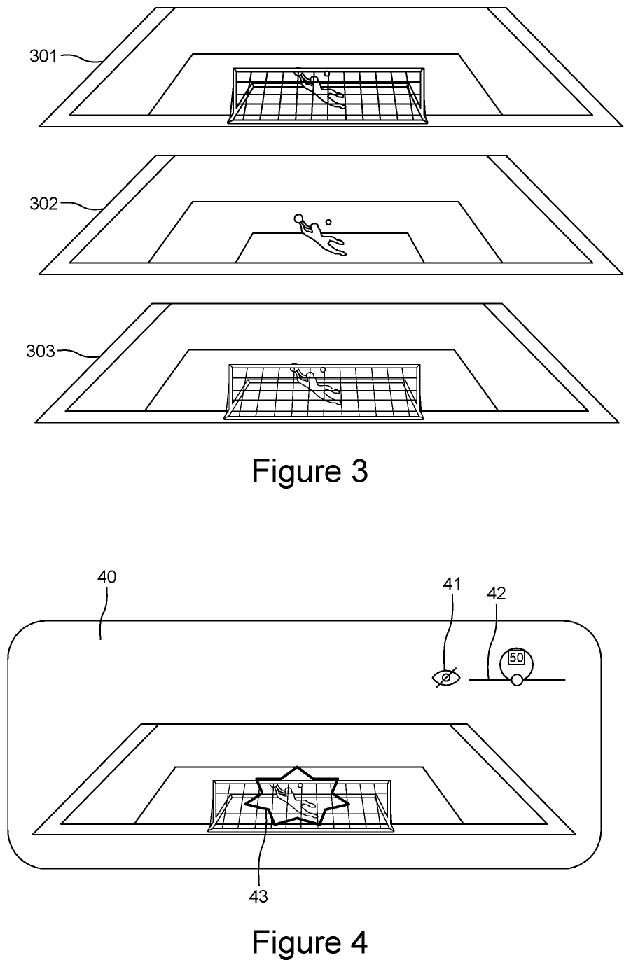

FIG. 3 illustrates the removal/transparency feature in the context of a soccer match volumetric capture, according to a non-limiting embodiment of the present principles. In this scenario, a rig of cameras is positioned behind the goal. From this point of view, a regular monoscopic acquisition would fail to provide relevant information about the match because of the occlusions due to the presence of the goal and of the goalkeeper as illustrate by image 301. With a volumetric acquisition making use of multiple cameras, some of the input cameras capture image information beyond the goal making possible to reconstruct a virtual image where the goal is removed as in image 302, or where the goal and the goalkeeper are made transparent as in image 303. On a corner or penalty action, such a new point of view could be of high interest for possible broadcasters and/or viewers. Such advanced effects may be reproduced in very different scenarios (e.g. baseball match where one could synthesize a view from the batsman position, the batsman having been removed, theatrical performance where the audience could be arbitrarily removed, . . . ) and may offer opportunities to content producers. The removing an object is a special case of making this object transparent, where the level of transparency is set to to 1 (i.e. 100% transparency).

Provided examples relate only to transparency. However, the present principles may apply without loss of generality to any other kind of rendering effect, like color filtering, blurring, distorting, noising, etc.

A rendering device receiving a volumetric video, for example encoded under the shape of a regular MIV bitstream, may implement the transparency effect at the rendering stage by a spatio-angular culling (and possible patch filtering process) combined with alpha blending (Painter's algorithm or more advanced techniques such as OIT—Order-independent Transparency). However, the content producer may want to limit this feature or at least moderate/recommend its usage in some specific cases for narrative, commercial or quality purposes. It would be for instance the case to prevent the user from removing some advertisement required by the broadcaster. In a story telling context, making certain areas transparent/empty could make the whole story inconsistent or even not understandable. Finally, removing some parts of the scene could even cause undesirable disocclusions that may affect the visual quality of experience.

According to the present principles, a specific information is embedded in the bitstream for transparency (or other rendering) effects to be rendered consistently with the content producer/broadcaster wishes. A format of metadata describing this effect is proposed. In an embodiment, it may rely on the extension of an existing V3C SEI (Supplemental Enhancement Information) called Scene Object Information which is enriched, according to the present principles, by additional transparency-related syntactical elements. In another embodiment, an out-of-band mechanism relying on the concept of entity defined in the core MIV bitstream is also proposed as an alternative to convey a similar information. The present principles may apply to other formats of volumetric video metadata.

In a first embodiment of the present principles, the transparency recommendation is signaled in metadata associated with the volumetric content, for example as an extension of an existing V3C SEI message. The ISO/IEC 23090-5 Visual Volumetric Video-based coding (V3C) specification already provides a Volumetric Annotation family of SEI messages to signal various object properties and assign these objects to patches.

Within this metadata family, the Scene Object Information SEI message defines a set of objects that may be present in a volumetric scene, and optionally assigns different properties to these objects. These objects could then potentially be associated with different types of information, including patches. Among all the existing properties, various rendering-related information (material id, point style) may be signaled in this SEI message, as well as some more geometric properties such as an optional 3D bounding box (e.g. soi_3d_bounding_box_present_flag in italic in Table 1).

According to the present principles, an additional property to be used at the rendering side for making some objects transparent and controlling the associated transparency intensity is proposed. Similar metadata may be added for other kinds of rendering effects. In Table 1, the Scene Object Information SEI message of V3C is amended to embed the transparency-related syntactic elements (in bold). This table is provided as an example of possible syntax for metadata signaling the transparency effect.

TABLE 1

| | |
|---|---|
| scene_object_information( payloadSize ) { | |
| soi_persistence_flag | u(1) |
| soi_reset_flag | u(1) |
| soi_num_object_updates | ue(v) |
| if( soi_num_object_updates > 0 ) { | |
| soi_simple_objects_flag | u(1) |
| if( soi_simple_objects_flag == 0) { | |
| soi_object_label_present_flag | u(1) |
| soi_priority_present_flag | u(1) |
| soi_object_hidden_present_flag | u(1) |
| soi_object_dependency_present_flag | u(1) |
| soi_visibility_cones_present_flag | u(1) |
| soi_3d_bounding_box_present_flag | u(1) |
| soi_collision_shape_present_flag | u(1) |
| soi_point_style_present_flag | u(1) |
| soi_material_id_present_flag | u(1) |
| soi_extension_present_flag | u(1) |
| soi_{—}transparency_{—}range_{—}present_{—}flag | u(1) |
| } | |
| else { | |
| soi_object_label_present_flag = 0 | |
| soi_priority_present_flag = 0 | |
| soi_object_hidden_present_flag = 0 | |
| soi_object_dependency_present_flag = 0 | |
| soi_visibility_cones_present_flag = 0 | |
| soi_3d_bounding_box_present_flag = 0 | |
| soi_collision_shape_present_flag = 0 | |
| soi_point_style_present_flag = 0 | |
| soi_material_id_present_flag = 0 | |
| soi_extension_present_flag = 0 | |
| soi_{—}transparency_{—}range_{—}present_{—}flag = 0 | |
| } | |
| if( soi_3d_bounding_box_present_flag ) { | |
| soi_3d_bounding_box_scale_log2 | u(5) |
| } | |
| soi_log2_max_object_idx_updated_minus1 | u(5) |
| if( soi_object_dependency_present_flag ) | |
| soi_log2_max_object_dependency_idx | u(5) |
| for( i = 0; i < soi_num_object_updates; i++ ) { | |
| soi_object_idx[ i ] | u(v) |
| k = soi_object_idx[ i ] | |
| soi_object_cancel_flag[ k ] | u(1) |
| ObjectTracked[ k ] = !soi_object_cancel_flag[ k ] | |
| if( !soi_object_cancel_flag[ k ] ) { | |
| if( soi_object_label_present_flag ) { | |
| soi_object_label_update_flag[ k ] | u(1) |
| if( soi_object_label_update_flag[ k ] ) | |
| soi_object_label_idx[ k ] | ue(v) |
| } | |
| if( soi_priority_present_flag ) { | |
| soi_priority_update_flag[ k ] | u(1) |
| if( soi_priority_update_flag[ k ] ) | |
| soi_priority_value[ k ] | u(4) |
| } | |
| if( soi_object_hidden_present_flag ) | |
| soi_object_hidden_flag[ k ] | u(1) |
| if( soi_object_dependency_present_flag ) { | |
| soi_object_dependency_update_flag[ k ] | u(1) |
| if( soi_object_dependency_update_flag[ k ] ) { | |
| soi_object_num_dependencies[ k ] | u(4) |
| for( j = 0; j < soi_object_num_dependencies[ k ]; j++ ) | |
| soi_object_dependency_idx[ k ][ j ] | u(v) |
| } | |
| } | |
| if( soi_visibility_cones_present_flag ) { | |
| soi_visibility_cones_update_flag[ k ] | u(1) |
| if( soi_visibility_cones_update_flag[ k ]) { | |
| soi_direction_x[ k ] | i(16) |
| soi_direction_y[ k ] | i(16) |
| soi_direction_z[ k ] | i(16) |
| soi_angle[ k ] | u(16) |
| } | |
| } | |
| if( soi_3d_bounding_box_present_flag ) { | |
| soi_3d_bounding_box_update_flag[ k ] | u(1) |
| if( soi_3d_bounding_box_update_flag[ k ]) { | |
| soi_3d_bounding_box_x[ k ] | ue(v) |
| soi_3d_bounding_box_y[ k ] | ue(v) |
| soi_3d_bounding_box_z[ k ] | ue(v) |
| soi_3d_bounding_box_size_x[ k ] | ue(v) |
| soi_3d_bounding_box_size_y[ k ] | ue(v) |
| soi_3d_bounding_box_size_z[ k ] | ue(v) |
| } | |
| } | |
| if( soi_collision_shape_present_flag ) { | |
| soi_collision_shape_update_flag[ k ] | u(1) |
| if(soi_collision_shape_update_flag[ k ]) | |
| soi_collision_shape_id[ k ] | u(16) |
| } | |
| if( soi_point_style_present_flag ) { | |
| soi_point_style_update_flag[ k ] | u(1) |
| if( soi_point_style_update_flag[ k ] ) { | |
| soi_point_shape_id[ k ] | u(8) |
| soi_point_size[ k ] | u(16) |
| } | |
| } | |
| if( soi_material_id_present_flag ) { | |
| soi_material_id_update_flag[ k ] | u(1) |
| if( soi_material_id_update_flag[ k ] ) | |
| soi_material_id[ k ] | u(16) |
| } | |
| if( soi_{—}transparency_{—}range_{—}present_{—}flag ) { | |
| soi_{—}transparency_{—}range_{—}update_{—}flag[ k ] | u(1) |
| if( soi_{—}transparency_{—}range_{—}update_{—}flag [ k ]) { | |
| soi_{—}min_{—}transparency[ k ] | u(8) |
| soi_{—}max_{—}transparency[ k ] | u(8) |
| } | |
| } | |
| } | |
| } | |
| } | |
| } | |

The semantics of the introduced syntactical elements are defined as follows:

soi_transparency_range_present_flag equal to 1 indicates that transparency range is present in the current scene object information SEI message. soi_transparency_range_present_flag equal to 0 indicates that transparency range information is not present.
soi_transparency_range_update_flag[k] equal to 1 indicates that transparency range update information is present for an object with object index k. soi_transparency range_update_flag[k] equal to 0 indicates that transparency range update information is not present.
soi_min_transparency[k] indicates the minimum recommended transparency, MinTransparency[k], of an object with index k. The default value of soi_min_transparency[k] is equal to 0 (the object is fully opaque).
soi_max_transparency[k] indicates the maximum recommended transparency, MaxTransparency[k], of an object with index k. The default value of soi_max_transparency[k] is equal to 0 (the object is fully opaque).

It is a requirement of bitstream conformance that MinTransparency[k] is lower or equal to MaxTransparency[k].

A V3C SEI message defines a set of objects in the scene with various properties. According to the present principles, such a SEI message may comprise a value range for a rendering effect, for example a transparency range, associated with an object of the three-dimensional scene. The message is repeated in the bitstream as soon as any property of the object changes.

Each defined object may be associated with a set of patches by the means of another Patch Information SEI message defined at the patch level of the metadata and described in Table 2. The optional syntactic element pi_patch_object_idx is associating a patch with a defined object.

TABLE 2

| | De- |
|---|---|
| | scrip- |
| | tor |
| patch_information( payloadSize ) { | |
| pi_persistence_flag | u(1) |
| pi_reset_flag | u(1) |
| pi_num_tile_updates | ue(v) |
| if( pi_num_tile_updates > 0 ) { | |
| pi_log2_max_object_idx_tracked_minus1 | u(5) |
| pi_log2_max_patch_idx_updated_minus1 | u(4) |
| } | |
| for( i = 0; i < pi_num_tile_updates; i++ ) { | |
| pi_tile_id[ i ] | ue(v) |
| j = pi_tile_id[ i ] | |
| pi_tile_cancel_flag[ j ] | u(1) |
| pi_num_patch_updates[ j ] | ue(v) |
| for( k = 0; k < pi_num_patch_updates[ j ]; k++ ) { | |
| pi_patch_idx[ j ][ k ] | u(v) |
| p = pi_patch_idx[ j ][ k ] | |
| pi_patch_cancel_flag[ j ][ p ] | u(1) |
| if( !pi_patch_cancel_flag[ j ][ p ] ) { | |
| pi_patch_number_of_objects_minus1[ j ][ p ] | ue(v) |
| m = pi_patch_number_of_objects_minus1[ j ][ p ] + 1 | |
| for( n = 0; n < m; n++ ) | |
| pi_patch_object_idx[ j ][ p ][ n ] | u(v) |
| } | |
| } | |
| } | |
| } | |

To control the usage of the rendering effect at the decoding stage according to the present principles, various options may be considered.

In the example of FIG. 3, the rendering effect is the transparency effect and an object described in the metadata is associated with the goalkeeper (another one may be associated with the goal frame and yet another one with the ball).
a. If no patch is associated with this object and soi_3d_bounding_box_present_flag is enabled, then transparency modifications in the recommended range at the decoding stage are allowed within the associated bounding box only.
b. If some patches are associated to this object and soi_3d_bounding_box_present_flag is disabled, then transparency modifications in the recommended range at the decoding stage are allowed for these specific patches only.
c. If some patches are associated to this object and soi_3d_bounding_box_present_flag is enabled, then transparency modifications in the recommended range at the decoding stage are only allowed for the part of these specific patches included in the associate bounding box.

Operating according to the first embodiment allows a flexible management of the rendering effect like transparency modifications at the decoding side, either as 3D spatial recommendations or as a per patch guidance.

In a second embodiment, the transparency recommendation is signaled as an out-of-band mechanism relying on an entity id concept, for instance as defined in the MIV extension of the Patch Data Unit and described in Table 3. The entity id concept is close to the concept of object introduced in relation to the first embodiment. Differences lie in the fact that an entity is an id-only concept (no associated property) and that it is defined in the core stream (and not in an “optional” SEI message).

TABLE 3

| | Descrip- |
|---|---|
| | tor |
| pdu_miv_extension( tileID, p ) { | |
| if( vme_max_entity_id > 0 ) | |
| pdu_entity_id[ tileID ][ p ] | u(v) |
| if( asme_depth_occ_threshold_flag ) | |
| pdu_depth_occ_threshold[ tileID ][ p ] | u(v) |
| if( asme_patch_attribute_offset_enabled_flag ) | |
| for( c = 0; c < 3; c++ ) { | |
| pdu_attribute_offset[ tileID ][ p ][ c ] | u(v) |
| } | |

As illustrated in Table 3, each patch may be associated to one specific entity making use of the pdu_entity_id syntactic element. Thus, it is possible to define one or several entity ids gathering patches affected by the rendering effect and to have a per patch rendering modification management. The associated rendering effect information (e.g. range, update, activation) is handled out-of-band by the rendering client implementation.

FIG. 4 shows an example user interface 40 (UI) for a rendering device implementing the transparency rendering effect. At the decoding side, when the rendering device receives the video bitstream comprising an atlas image packing patch pictures and the associated metadata comprising transparency-related metadata according to the present principles, a mechanism coupled with UI 40 may, for instance, highlight some parts 43 of the scenes, candidate for the rendering effect. The metadata are parsed searching for the associated SEI messages (Scene Object Information SEI message) and when an object with possible transparency level modification is detected (soi_transparency_range_present_flag enabled), its reprojected bounding box 43 on the end-user screen is, for instance, highlighted. An associated slider 42 allow the user to manage the transparency level of the object. The minimal and maximal possible values are obtained from the associated metadata. An “invisible” button 41 may also be proposed as a shortcut to make the object totally transparent if it is possible (i.e. if the minimal transparency value in the metadata equals 0).

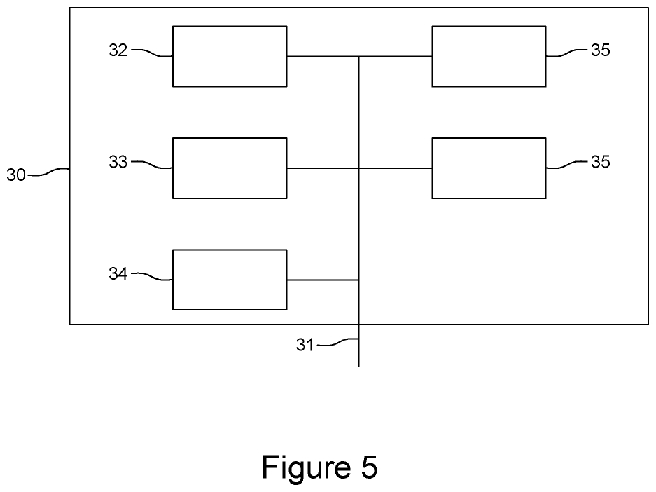

FIG. 5 shows an example architecture of a device 30 which may be configured to implement a method described in relation with FIGS. 3 and 4.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 belongs to a set comprising:
a mobile device;
a communication device;
a game device;
a tablet (or tablet computer);
a laptop;
a still picture or a video camera, for instance equipped with a depth sensor;
a rig of still picture or video cameras;
an encoding chip;
a server (e.g. a broadcast server, a video-on-demand server or a web server).

The syntax of a data stream encoding a volumetric video and associated metadata may consist in a container which organizes the stream in independent elements of syntax. The structure may comprise a header part which is a set of data common to every syntax element of the stream. For example, the header part comprises some of metadata about syntax elements, describing the nature and the role of each of them. The structure also comprises a payload comprising a first element of syntax and a second element of syntax 43. The first element of syntax comprises data representative of the media content items describes in the nodes of the scene graph related to virtual elements. Images like patch atlases and other raw data may have been compressed according to a compression method. The second element of syntax is a part of the payload of the data stream and comprises metadata encoding the scene description as described in tables 1 to 3.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising:
obtaining an atlas image, the atlas image packing patch pictures, the atlas image being representative of a three-dimensional scene and obtaining metadata comprising a value range for a rendering effect associated with an object of the three-dimensional scene and comprising data associating the object with patch pictures of the atlas image;
rendering a view of the three-dimensional scene by inverse projecting the pixels of the atlas image for a point of view and by applying a default value for the rendering effect to the pixels of the patch pictures associated with the object;
displaying an interface to allow a user to modify the value of the rendering effect in the value range.

2. The method of claim 1, wherein when the value of the rendering effect is modified to a new value, the method comprises:
on condition that the metadata comprise data associating the object with a bounding box, apply the new value to pixels of the associated patch pictures inverse projected in the bounding box;
otherwise, apply the new value to pixels of the associated patch pictures.

3. (canceled)

4. The method of claim 1, wherein the metadata comprise an information indicating whether the value range for the rendering effect associated with the object is an update of a previous or default value range for the rendering effect for the object.

5. The method of claim 1, wherein the rendering effect is a transparency effect or a color filtering or a blurring or a contrast adapting.

6. The method of claim 1, wherein the metadata are encoded in Supplemental Enhanced Information messages.

7. A device comprising a memory associated with a processor configured for:
obtaining an atlas image, the atlas image packing patch pictures, the atlas image being representative of a three-dimensional scene and obtaining metadata comprising a value range for a rendering effect associated with an object of the three-dimensional scene and comprising data associating the object with patch pictures of the atlas image;
rendering a view of the three-dimensional scene by inverse projecting the pixels of the atlas image for a point of view and by applying a default value for the rendering effect to the pixels of the patch pictures associated with the object;
displaying an interface to allow a user to modify the value of the rendering effect in the value range.

8. The device of claim 7, wherein when the value of the rendering effect is modified to a new value, the processor is configured for:
on condition that the metadata comprise data associating the object with a bounding box, apply the new value to pixels of the associated patch pictures inverse projected in the bounding box;
otherwise, apply the new value to pixels of the associated patch pictures.

9. (canceled)

10. The device of claim 7, wherein the metadata comprise an information indicating whether the value range for the rendering effect associated with the object is an update of a previous or default value range for the rendering effect for the object.

11. The device of claim 7, wherein the rendering effect is a transparency effect or a color filtering or a blurring or a contrast adapting.

12. The device of claim 7, wherein the metadata are encoded in Supplemental Enhanced Information messages.

13. A non-transitory storage medium storing video data comprising an atlas image, the atlas image packing patch pictures, the atlas image being representative of a three-dimensional scene and metadata comprising instructions to limit a change of a value for a rendering effect associated with an object of the three-dimensional scene in a value range and comprising data associating the object with patch pictures of the atlas image.

14. (canceled)

15. The non-transitory storage medium of claim 13, wherein the metadata comprise an information indicating whether the value range for the rendering effect associated with the object is an update of a previous or default value range for the rendering effect for the object.

16. The non-transitory storage medium of claim 13, wherein the rendering effect is a transparency effect or a color filtering or a blurring or a contrast adapting.

17. The non-transitory storage medium of claim 13, wherein the metadata are encoded in Supplemental Enhanced Information messages.
